(19) United States
(12) Patent Application Publication
(10) Pub. No.: US 2015/0134719 A1
(43) Pub. Date: May 14, 2015

(54) THIRD PARTY APPLICATION DELIVERY VIA AN AGENT PORTAL

(71) Applicant: KASEYA INTERNATIONAL LIMITED, St. Helier (JE)

(72) Inventor: Maximo Marcos Pena-Scheker, Henderson, NV (US)

(73) Assignee: KASEYA INTERNATIONAL LIMITED, St. Helier (JE)

(21) Appl. No.: 14/078,952

(22) Filed: Nov. 13, 2013

(51) Int. Cl. H04L 29/06

(52) U.S. Cl. CPC H04L 67/42
USPC 709/202

(57) ABSTRACT

An application access menu or user interface may provide a user machine operating on an enterprise network with access to an agent portal that determines the user machine authentication and which provides access to receive an application user interface. The client machine may then select an application to be used on the client machine and receive approval from a virtual system administrator application prior to receiving access to the application selected.

### TECHNICAL FIELD OF THE APPLICATION

This application relates to providing access to various cloud-based or remote application server applications, and more specifically, to providing a client machine on an enterprise network with seamless access to various preapproved applications without requiring an administrator to approve the user selection prior to providing application access to the client machine.

### BACKGROUND OF THE APPLICATION

Conventionally, applications that manage and/or provide resourceful functions to computers deployed in the enterprise network are limited to administrator use only. Scheduling, deploying and managing application use is generally a job function assigned to a person that is not part of the everyday operations performed by enterprise users.

Agent portals are used to access third party software applications. However, end user or ‘users’ who are seeking access to other applications which are accessible to the users but are currently not installed and/or operating on the user's device, may desire to initiate the application accessing, loading and/or setup procedures without having to wait for approval, a ticket response, administrator overseeing, etc. Various applications may be organized and presented to the users without any delay.

### SUMMARY OF THE APPLICATION

One embodiment of the present application may include a method that provides accessing an agent portal via a client machine, receiving an application user interface, selecting an application to be used on the client machine, receiving approval from a virtual systems administrator application, and receiving access to the application selected.

Another example embodiment may provide an apparatus that includes a transmitter configured to access an agent portal, a receiver configured to receive an application user interface, and a processor configured to select an application to be used on the client machine. The receiver is also configured to receive approval from a virtual systems administrator application, and receive access to the application selected.

### BRIEF DESCRIPTION OF THE DRAWINGS

FIG. 1A illustrates an example network configuration of a client accessing approved applications, according to example embodiments of the present application.

FIG. 1B illustrates an example logic diagram of a client accessing approved applications, according to example embodiments of the present application.

FIG. 2A illustrates an example application access list user interface according to example embodiments.

FIG. 2B illustrates an example application selection user interface according to example embodiments.

FIG. 2C illustrates another example application selection user interface according to example embodiments.

FIG. 3 illustrates an example system diagram of a communication session between various network entities, according to example embodiments of the present application.

FIG. 4 illustrates a flow diagram of an example method according to an example embodiment of the present application.

FIG. 5 illustrates a system configuration that is configured to perform one or more operations corresponding to the example embodiments.

FIG. 6 illustrates an example network entity device configured to store instructions, software, and corresponding hardware for executing the same, according to example embodiments of the present application.

### DETAILED DESCRIPTION OF THE APPLICATION

It will be readily understood that the components of the present application, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present application, the application may be applied to many types of network data, such as, packet, frame, datagram, etc. For purposes of this application, the term “message” also includes packet, frame, datagram, and any equivalents thereof. Furthermore, while certain types of messages and signaling are depicted in exemplary embodiments of the application, the application is not limited to a certain type of message, and the application is not limited to a certain type of signaling.

According to example embodiments of the present application, an administrator may be any information technology (IT) systems administrator, IT service provider, and/or computer owner/operator who provides administrative functions to the computer devices, communication based connections and other network resources. An administrator machine may be any network-connected computer device operated by the administrator. The administrator machines may be connected directly to a server machine, or over a remote network connection to a server, managed machines and other computer networking machines.

A virtual systems administrator server and/or application may be a web-based application that permits the administrator machine, server, etc., to manage one or more remotely managed machines or client devices. A secure network channel may be setup and established between the systems administrator machine and the managed machine via the systems administrator application. The secure network channel may provide connections over which data packets may be exchanged. The network channel may pass through a wide area network (WAN) (e.g. the Internet) or through a private local area network (LAN).

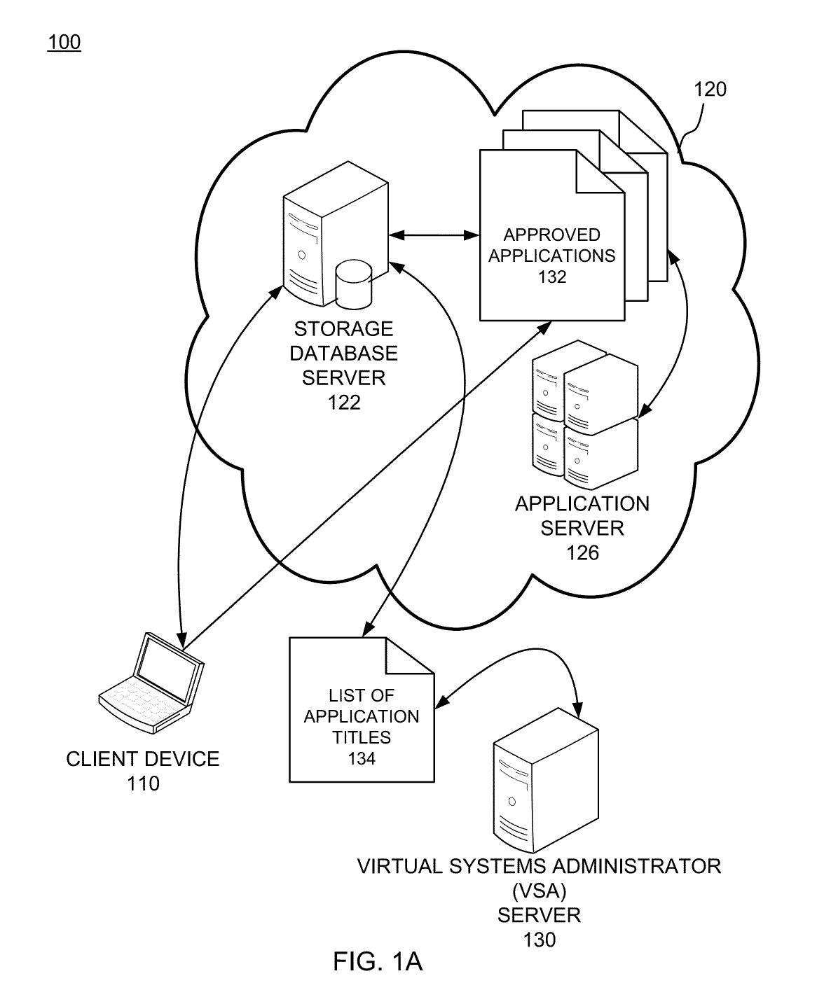

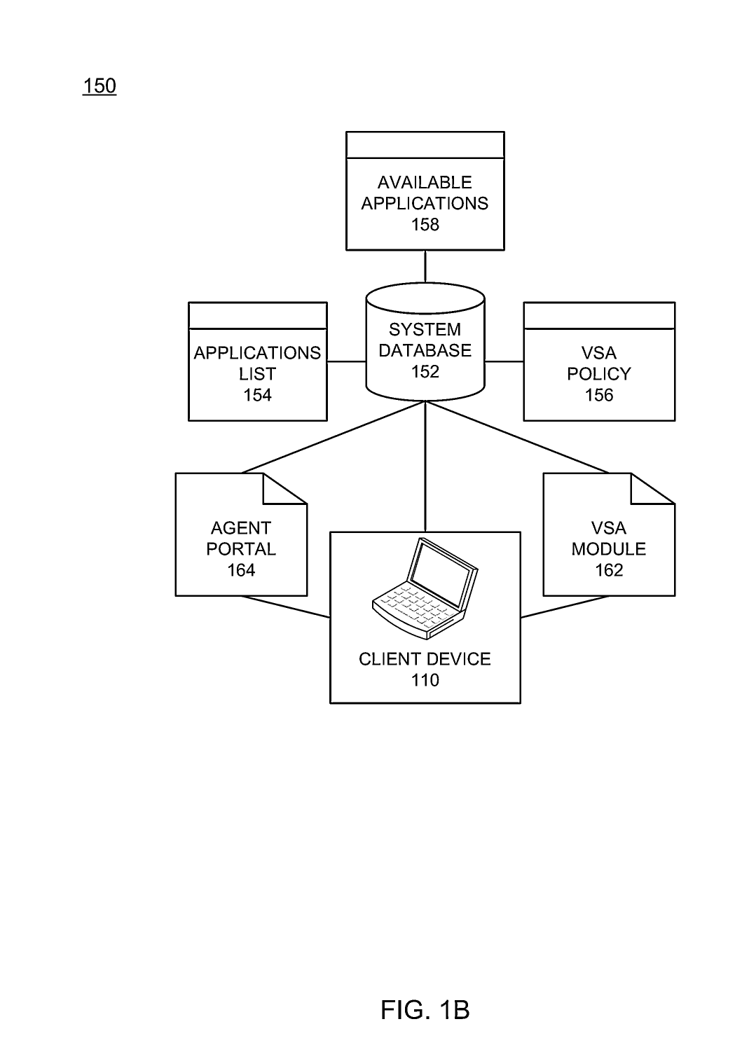

FIG. 1A illustrates an example network configuration of a client device accessing applications over the network with the assistance of a virtual systems administrator (VSA). Referring to FIG. 1A, the network 100 includes client device 110 which is in communication with a storage database server 122 to receive access to preapproved applications 132 via an application server 126, which may be part of a cloud computing environment 120. The communication may be over a WAN, such as, the Internet, or a LAN. The VSA 130 may be operating on a server, computer or other computing device. The client device 110 may be a laptop, computer, personal digital assistant, tablet, smart phone or any other computer network compatible device capable of establishing a communication path or secure channel with the VSA 130, which may also be any of the above computing devices.

In operation, the client device 110 may access a list of application titles 134 stored in the storage database 122. The list of application titles 134 available for the client device 110 to access and select a particular application may be based on certain preapproved applications 132 which are identified by an application server 126 by a database entry that indicates the application may be accessed by a client device 110 without administrative credentials. The application list may be managed by a VSA application which may be operating on its own VSA server 130 or operating as part of the application server 126.

Initially, the client device 110 would access an agent portal that is a type of client software used to access the VSA 130. The agent portal would provide a login and credential function that the user is required to perform prior to being permitted to access any applications. The agent portal would then provide an option for the user to access a program screen or user menu of available applications along with their name, description, etc. If the application is not approved, the VSA 130 can also manage the list to modify the approvals based on the user's credentials and access privileges.

FIG. 1B illustrates an example logic diagram of a client accessing approved applications, according to example embodiments of the present application. Referring to FIG. 1B, the logic diagram 150 includes a system database 152 that has various available applications 158 either in a tabulated list or as executables which are accessible to links to other application servers in the cloud. The system database 152 also accesses a VSA policy 156 which may determine which applications are accessible to which users and level of privileges. Also, an application list 154 may be established so the client device 110 can access the list and make selections. The client device 110 may also access a VSA module 162 that provides the rules and access privileges when the client device 110 is seeking access to the applications in the database 152. The client device 110 may launch an agent portal 164 to access the system database 152 which establishes a secure and active channel for the client device 110 to make application selections that are governed by the VSA module 162.

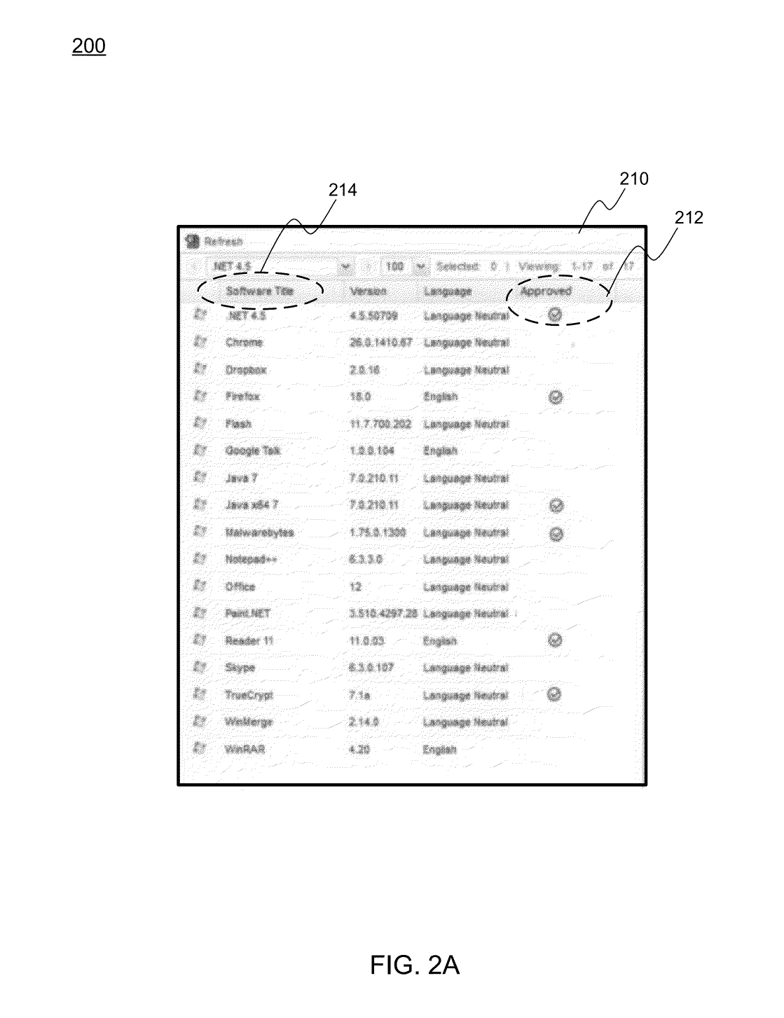

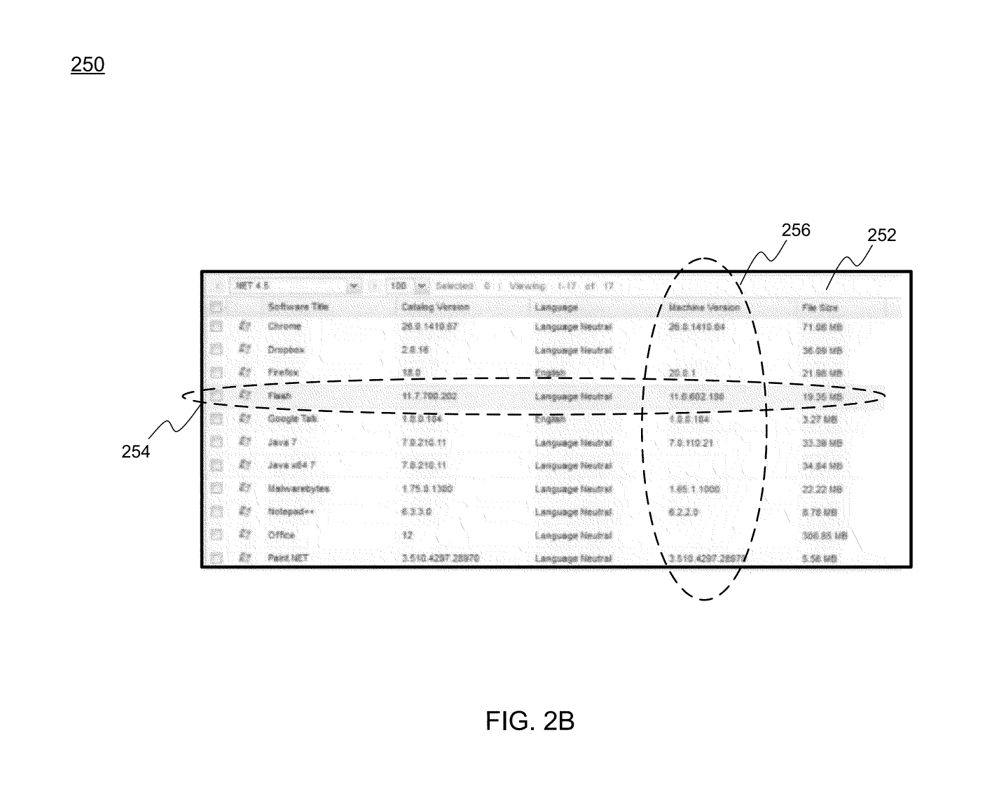

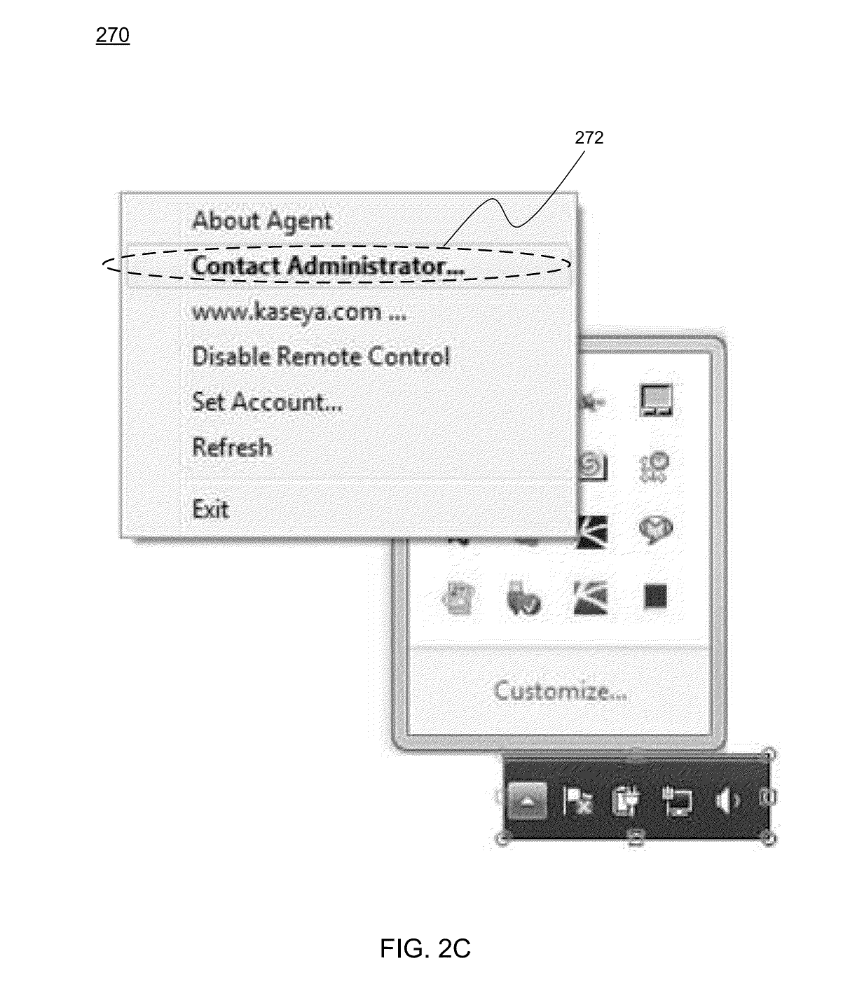

FIG. 2A illustrates an example application access list user interface according to example embodiments. Referring to FIG. 2A, the user interface 200 includes a main window portion 210 that includes a list of approved applications based on a predefined number of items to view at any given time. The application may be approved via a check box in the approved column 212. The title of the application 214 may also be listed as a column along with version, language and other application attributes. FIG. 2B illustrates an example application selection user interface according to example embodiments. Referring to FIG. 2B, the application list 250 includes additional application details, such as file size 252 and version information. The client computer device may receive a user selection 254 for a particular application.

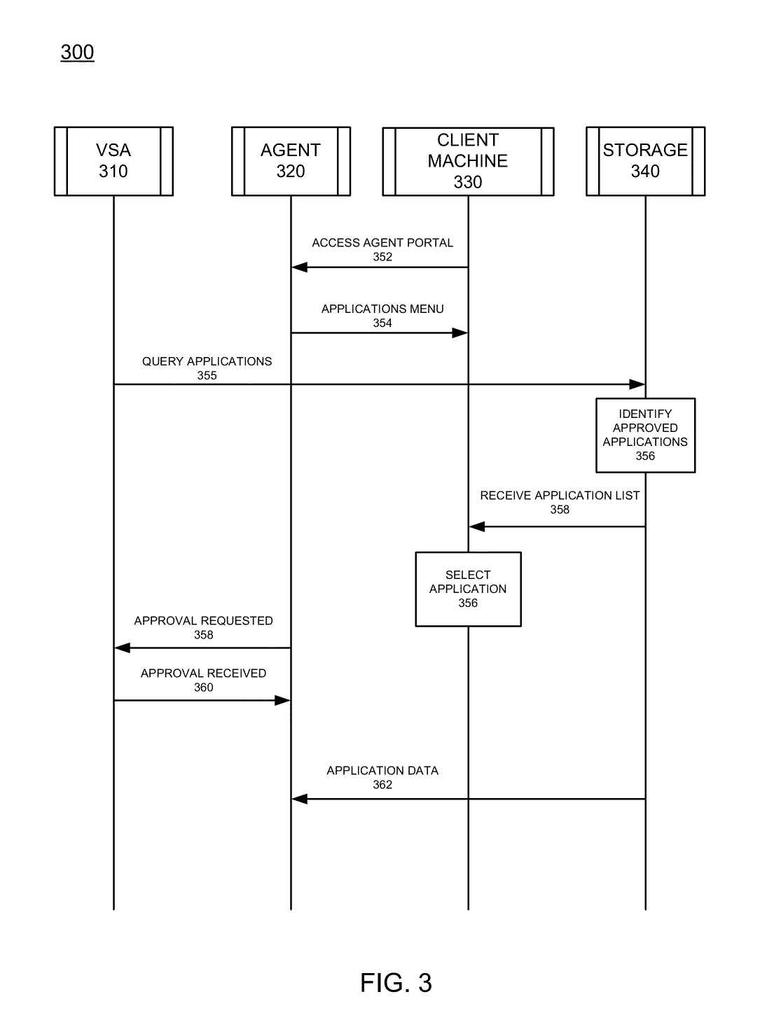

FIG. 3 illustrates the communication signaling diagram 300. Referring to FIG. 3, the VSA 310 may communicate as an application or server to the agent portal 320 and the corresponding client machine 330. The storage database 340 may provide access to certain applications that are approved by the VSA 310. In operation, the client machine or computer 330 may access the agent portal 320 by selecting the agent application 352. Next, the user credentials may be examined prior to provide the applications menu 354 to the client machine 330. The VSA 310 may then submit a query 355 to determine which applications are accessible to the client machine 330. The query may be sent to the database 340 and the applications may be retrieved according to an identification operation to determine which applications are approved 356. The list of applications are then updated or generated and provided 358 to the client machine 330 for review. An application may be selected 356 and the agent 320 may request approval 358 of the VSA 310 to ensure the application is accessible to the particular client operating the client machine 330. The approval may be requested 360 and the application data may then be provided to the client machine 330 via the agent portal 320.

According to example embodiments, the agent portal may initiate via the user initiating communication with the agent portal, which may be at the moment of opening and accessing an agent menu located within the application interface tray and selecting the “Contact Administrator” option. Upon selecting this “Contact Administrator” option 272 as illustrated in user interface 270 of FIG. 2C, the user may be logged onto the agent portal at which point information about their computer device, which is currently managed by the VSA 310 can be accessed. The information provided within the agent portal 320 includes the list of programs/applications available to the user, and which may be deployed to their computer device including information about the programs already installed as indicated on the ‘Machine Version’ column 256 of FIG. 2B.

The VSA 310 may perform certain administrative or management applications when accessed via a user application selection operation. For example, when the user selects an application to be deployed, the VSA 310 first verifies if the selected application version has or has not been installed on the user's machine and/or whether the current version available is newer than the version installed. The VSA 310 may initiate an uninstall, re-install, upgrade, downgrade procedure accordingly to accommodate the version currently available. Once those conditions are satisfied, a deployment schedule is created within the VSA 310 to provide the application with information that the logged-on user requires the selected application for the machine that is currently managed by the VSA 310, which may be the machine where the user is currently logged-on at that time.

Once the deployment schedule begins execution via the scheduled times, the VSA 310 may determine if the installer for the selected application is available on the VSA 310. If the installer is not available, the deployment schedule is reset for a predetermined amount of time (e.g., 2, 5, 10 minutes) into the future and a request is created to download the corresponding installation file from the cloud repository or storage 340 at the appropriate time dictated by the deployment schedule. Once the installation file is available and retrieved, an agent procedure is initiated on the target machine and the copying and execution of the installation file is performed. Once the application install deployment operation is completed, the agent 320 may generate a scan schedule for the user/client machine 330 that recently deployed the cloud stored application. The scan operation will transmit a report message to the VSA 310 that the application was successfully installed and that the machine is now on the most current version of the application.

The authorization procedure for being approved and accessing the application on the storage server 340 may provide a series of operations. For example, a systems administrator must access the VSA 310 and pre-approve the software application titles that are going to be made available within the agent portal 320. Once these applications are approved, users who connect to the agent portal 320 via their client machines 330 will be able to browse the catalog, select the application(s) needed and deploy them to their machines accordingly. Applications that have not been approved by a system administrator operating the VSA 310 will not be displayed on the agent portal interface (see ‘Software Titles’ in FIG. 2B). Similarly, a systems administrator may revoke approval of an application consequently removing it from the agent portal catalog. In order for a user to access one or more applications, all that is required is for the user to be logged on to a machine that is currently managed by an agent 320 in order to access the agent portal. Once a user navigates to the “Programs” screen, the user will then be able to browse through the list of applications approved by their system administrator.

After a user selects one or more applications, the user can deploy the selected application(s) to their client device 330 via a “Deploy Now” functionality within the “Programs” screen (not shown). This operation causes the client machine 330 to communicate with the VSA 310 to alert the application to create a deployment schedule(s) for the selected application(s) to be deployed on the managed application system that the user is currently accessing.

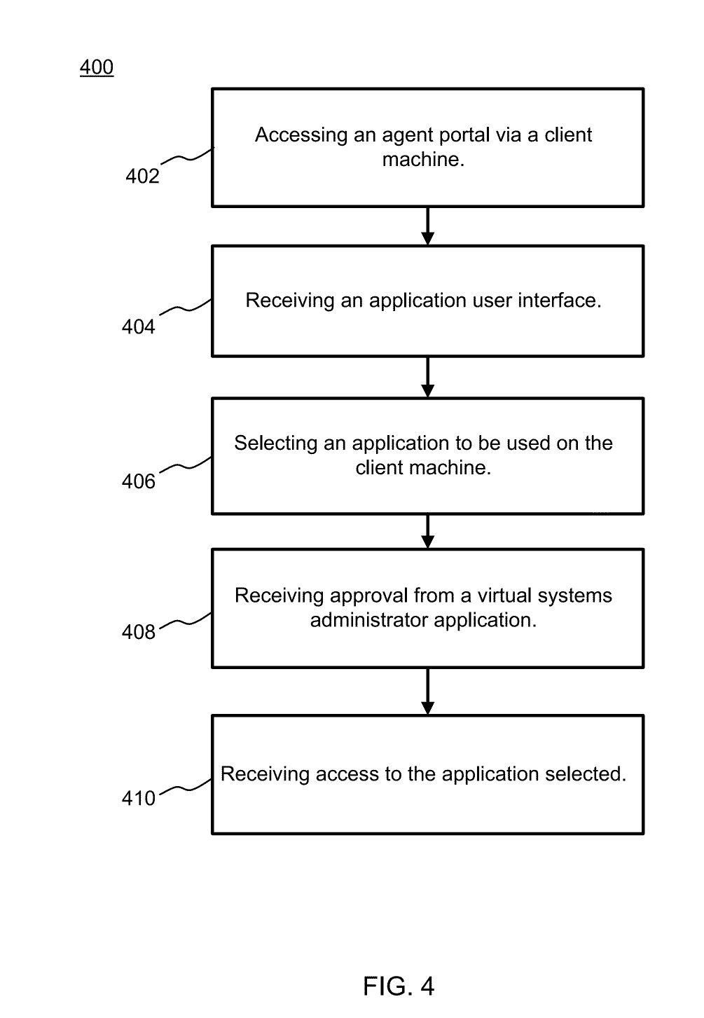

FIG. 4 illustrates a flow diagram of an example method of operation according to example embodiments. Referring to FIG. 4, the method 400 may provide accessing an agent portal via a client machine at operation 402 and receiving an application user interface at operation 404. The method may also provide selecting an application to be used on the client machine at operation 406, receiving approval from a virtual systems administrator application at operation 408, and receiving access to the application selected at operation 410.

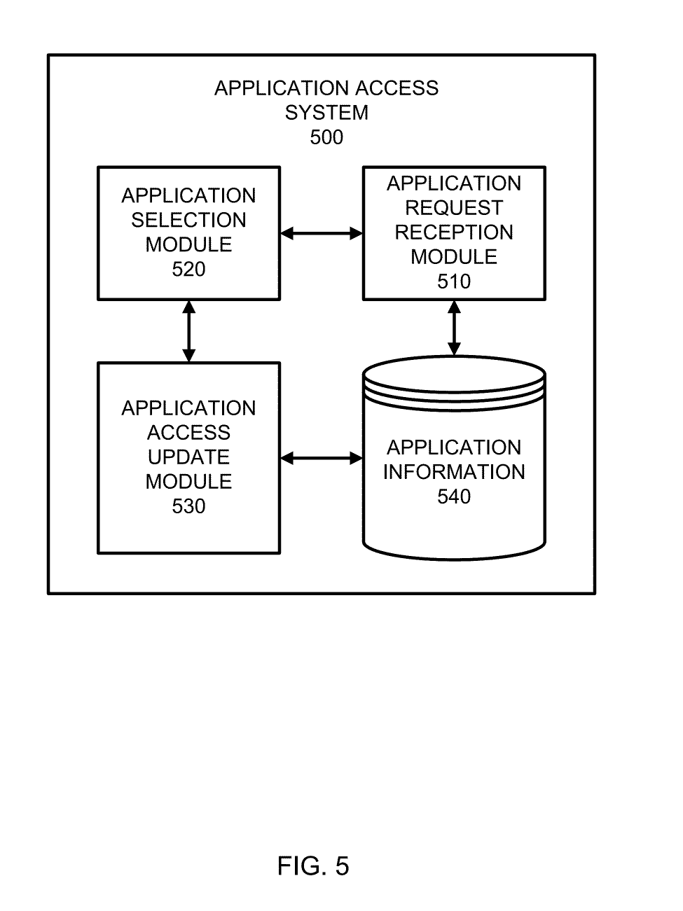

FIG. 5 illustrates an example system 500 used to perform any of the above-noted methods of operation or similar functions shared by example embodiments described herein. For example, the application access system 500 may include various modules, such as an application request reception module 510 that receives requests for certain applications, an application selection module 520 that selects an application and initiates application identification and checking procedures. An application access update module 530 that updates the records for application use, retrieval, authorization, etc. The application list, applications themselves, authorization rights, records, etc. may all be stored in a database 540 and referenced when necessary.

On example method of operation that may be performed by the system 500 may provide accessing an agent portal via a client machine and receiving an application user interface. The method may also include selecting an application to be used on the client machine and requesting that application by creating and sending a request to the request reception module 510. The method may also provide receiving approval from a virtual systems administrator application, and receiving access to the application selected via the application selection module 520.

In other operations, the application access update module 520 may query an application database to determine which applications are accessible to the client machine, generate a list of available applications responsive to the querying operation, and transmit the list of available applications to the client machine. The update module 530 may also update the list of available applications in the database 540 to include applications which were not previously available to the client machine. During application retrieval, a request message may be generated for requesting approval from the virtual systems administrator to determine whether the client machine has access privileges to use the requested application once the application has been selected.

In response, approval that the client machine has access to the requested application may be received, and the application may be retrieved from an application database. Responsive to selecting an application to be used on the client machine, the virtual systems administrator application may verify whether the current version of the selected application is the same as an application version installed on the client machine, and determine whether to create a deployment schedule to have the selected application installed on the client machine via the application selection module 520. The deployment schedule is created via the virtual systems administrator application upon determining that the application version installed on the client machine is not the same as the current version of the selected application.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

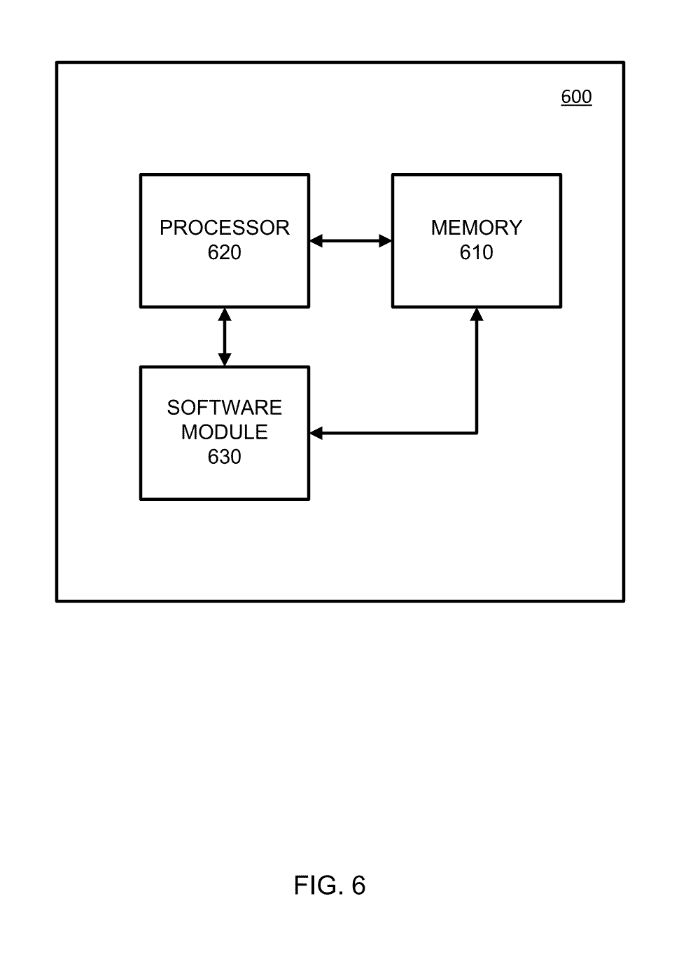

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example FIG. 6 illustrates an example network element 600, which may represent any of the above-described network components, etc.

As illustrated in FIG. 6, a memory 610 and a processor 620 may be discrete components of the network entity 600 that are used to execute an application or set of operations. The application may be coded in software in a computer language understood by the processor 620, and stored in a computer readable medium, such as, the memory 610. The computer readable medium may be a non-transitory computer readable medium that includes tangible hardware components in addition to software stored in memory. Furthermore, a software module 630 may be another discrete entity that is part of the network entity 600, and which contains software instructions that may be executed by the processor 620. In addition to the above noted components of the network entity 600, the network entity 600 may also have a transmitter and receiver pair configured to receive and transmit communication signals (not shown).

Although an exemplary embodiment of the system, method, and computer readable medium of the present invention has been illustrated in the accompanied drawings and described in the foregoing detailed description, it will be understood that the invention is not limited to the embodiments disclosed, but is capable of numerous rearrangements, modifications, and substitutions without departing from the spirit or scope of the invention as set forth and defined by the following claims. For example, the capabilities of the system of FIG. 5 can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of the invention, as generally described and illustrated in the figures herein, may be arranged and designed in a wide variety of different configurations. Thus, the detailed description of the embodiments is not intended to limit the scope of the invention as claimed, but is merely representative of selected embodiments of the invention.

One having ordinary skill in the art will readily understand that the invention as discussed above may be practiced with steps in a different order, and/or with hardware elements in configurations that are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method comprising:
accessing an agent portal via a client machine;
receiving an application user interface;
selecting an application to be used on the client machine;
receiving approval from a virtual systems administrator application; and
receiving access to the application selected.

2. The method of claim 1, further comprising:
querying an application database to determine which applications are accessible to the client machine;
generating a list of available applications responsive to the querying operation; and
transmitting the list of available applications to the client machine.

3. The method of claim 2, further comprising:
updating the list of available applications to include applications which were not previously available to the client machine.

4. The method of claim 1, further comprising:
requesting approval from the virtual systems administrator to determine whether the client machine has access privileges to use the requested application once the application has been selected.

5. The method of claim 4, further comprising:
receiving approval that the client machine has access to the requested application; and
retrieving the application from an application database.

6. The method of claim 1, further comprising:
responsive to selecting an application to be used on the client machine, verifying via the virtual systems administrator application whether the current version of the selected application is the same as an application version installed on the client machine; and
determining whether to create a deployment schedule to have the selected application installed on the client machine.

7. The method of claim 6, wherein the deployment schedule is created via the virtual systems administrator application upon determining that the application version installed on the client machine is not the same as the current version of the selected application.

8. An apparatus comprising:
a transmitter configured to access an agent portal;
a receiver configured to receive an application user interface; and
a processor configured to select an application to be used on the client machine, and
wherein the receiver is also configured to receive approval from a virtual systems administrator application, and receive access to the application selected.

9. The apparatus of claim 8, wherein the processor is further configured to query an application database to determine which applications are accessible to the client machine, and generate a list of available applications responsive to the query operation, and wherein the transmitter is further configured to transmit the list of available applications to a client machine.

10. The apparatus of claim 9, wherein the processor is further configured to update the list of available applications to include applications which were not previously available to the client machine.

11. The apparatus of claim 8, wherein the transmitter is further configured to transmit a request for approval from the virtual systems administrator to determine whether a client machine has access privileges to use the requested application once the application has been selected.

12. The apparatus of claim 11, wherein the receiver is further configured to receive approval that the client machine has access to the requested application, and the processor is further configured to retrieve the application from an application database.

13. The apparatus of claim 8, wherein responsive to selecting an application to be used on a client machine, the processor is configured to verify via the virtual systems administrator application whether the current version of the selected application is the same as an application version installed on the client machine, and determine whether to create a deployment schedule to have the selected application installed on the client machine.

14. The apparatus of claim 12, wherein the deployment schedule is created via the virtual systems administrator application upon determining that the application version installed on the client machine is not the same as the current version of the selected application.

15. A non-transitory computer readable storage medium configured to store instructions that when executed cause a processor to perform:
accessing an agent portal via a client machine;
receiving an application user interface;
selecting an application to be used on the client machine;
receiving approval from a virtual systems administrator application; and
receiving access to the application selected.

16. The non-transitory computer readable storage medium of claim 15, wherein the processor is further configured to perform:
querying an application database to determine which applications are accessible to the client machine;
generating a list of available applications responsive to the querying operation; and
transmitting the list of available applications to the client machine.

17. The non-transitory computer readable storage medium of claim 16, wherein the processor is further configured to perform:
updating the list of available applications to include applications which were not previously available to the client machine.

18. The non-transitory computer readable storage medium of claim 15, wherein the processor is further configured to perform:
requesting approval from the virtual systems administrator to determine whether the client machine has access privileges to use the requested application once the application has been selected.

19. The non-transitory computer readable storage medium of claim 18, wherein the processor is further configured to perform:
receiving approval that the client machine has access to the requested application; and
retrieving the application from an application database.

20. The non-transitory computer readable storage medium of claim 15, wherein the processor is further configured to perform:
responsive to selecting an application to be used on the client machine, verifying via the virtual systems administrator application whether the current version of the selected application is the same as an application version installed on the client machine; and
determining whether to create a deployment schedule to have the selected application installed on the client machine, wherein the deployment schedule is created via the virtual systems administrator application upon determining that the application version installed on the client machine is not the same as the current version of the selected application.
